(19) United States
(12) Patent Application Publication
(10) Pub. No.: US 2005/0087492 A1
(43) Pub. Date: Apr. 28, 2005

(54) Reverse osmosis water filtering system

(76) Inventor: Craig A Schmitt, Phoenix, AZ (US)

Correspondence Address: FISH & RICHARDSON PC, 225 FRANKLIN ST, BOSTON, MA, 02110, US

(21) Appl. No.: 10/692,398

(22) Filed: Oct. 23, 2003

(51) Int. Cl. B01D 61/00

(52) U.S. Cl. 210/650; 210/97; 138/40; 210/257.2

(57) ABSTRACT

A method of retrofitting a reverse osmosis system, includes rerouting concentrate water, received from a membrane, from a drain to a water source. The method also includes restricting a flow of the concentrate water to the water source. Restricting the flow of concentrate water may include installing a flow restrictor.

### TECHNICAL FIELD

This disclosure relates to reverse osmosis water filtering systems.

### BACKGROUND

A typical reverse osmosis water filtering system used in purifying water includes a semi-permeable membrane. Typically, a pressure is applied to incoming water that forces the incoming water through the membrane. The membrane filters impurities from the incoming water leaving purified water on the other side of the membrane called permeate water. The impurities left on the membrane are washed away by a portion of the incoming water that does not pass through the membrane. The impurities and the water used to wash them away from the membrane is called concentrate water.

### SUMMARY

In one aspect, the invention is a method of retrofitting a reverse osmosis system. The method includes rerouting concentrate water, received from a membrane, from a drain to a water source. The method also includes restricting a flow of the concentrate water to the water source.

A zero waste reverse osmosis water filtering system reduces by a considerable amount, the volume of concentrate water from being disposed down the drain. Instead of disposing of the concentrate water, the concentrate water is recycled and used again. Typically, in standard reverse osmosis water filtering systems, the ratio of concentrate water to permeate water is typically about 3 or 4 to 1. Thus, for every gallon of permeate water generated, the zero waste reverse osmosis water filtering system can save 3 to 4 gallons of water.

### DESCRIPTION OF THE DRAWINGS

FIG. 1 is a diagrammatic plan view of a reverse osmosis water filtering system (Prior art).

FIG. 2 is a diagrammatic plan view of a zero-waste reverse osmosis water filtering system.

FIG. 3 is a process flow diagram for conversion of a reverse osmosis water filtering system of FIG. 1 to a zero waste reverse osmosis water filtering system of FIG. 2.

FIG. 4 is a diagrammatic view of another example of a zero waster reverse osmosis water filtering system.

### DESCRIPTION

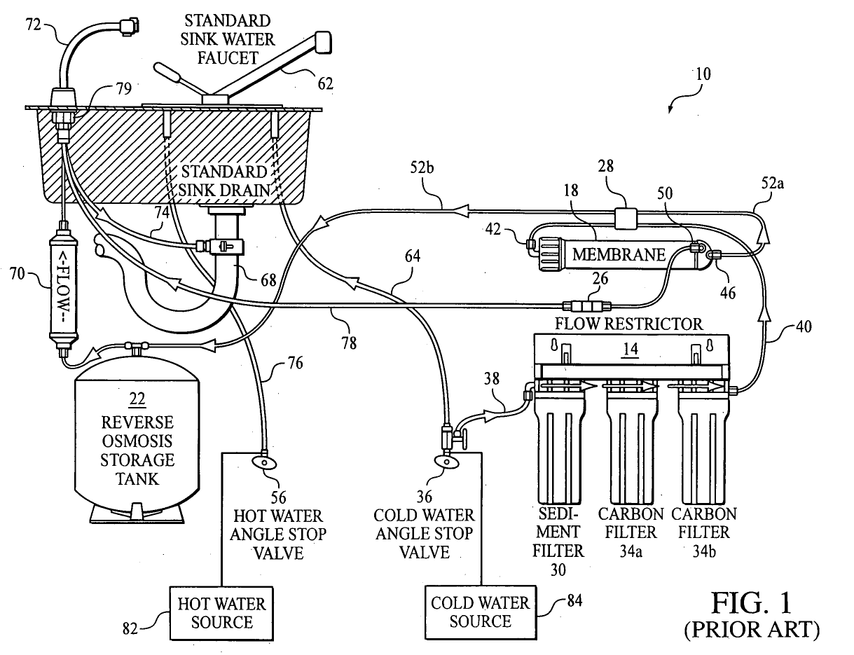

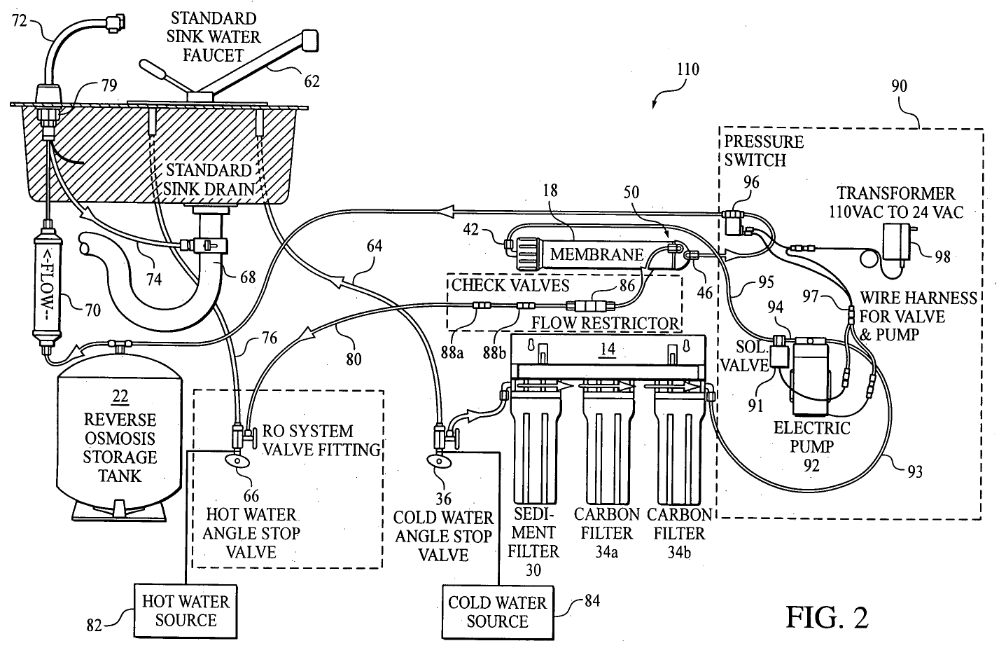

Referring to FIGS. 1-3, a typical prior art reverse osmosis water filtering system 10 is modified using a process 200 to form a zero waste reverse osmosis (ZWRO) water filtering system 110. Process 200 reroutes concentrate water from disposal as waste down a drain 68 to a hot water source 82 to be used again thereby conserving water.

System 10 includes a filter system 14, a reverse osmosis membrane 18, a reverse osmosis storage tank 22, a flow restrictor 26, a shut-off valve 28, a carbon filter 70 and an air gap faucet 72. Filter system 14 includes a sediment filter 30 and carbon filters (e.g., carbon filter 34a and carbon filter 34b). Intake water enters system 10 from a cold water angle stop valve 36, which is connected to a cold water source 84, and is routed through an intake tube 38 to filter system 14. Cold water angle stop valve 36 is also connected to a standard faucet 62 through a cold water faucet line 64 providing cold water to the standard faucet.

Sediment filter 30 removes sediment such as sand and dirt and the like from the intake water. Carbon filters 34a and 34b remove chlorine and other contaminants that cause bad color, odor and taste. The filtered water is routed to membrane 18 through a water tube 40.

Membrane 18 includes three ports: an intake port 42, a permeate outlet port 46 and a concentrate outlet port 50. Intake port 42 receives filtered intake water from filter system 14 through water tube 40. Permeate water is routed from outlet port 46 through permeate tubes 52a and 52b and shut-off valve 28 to tank 22 to be stored under pressure. Shut-off valve 28 is automatic and stops the flow of water to membrane 18 and to tank 22. When air gap faucet 72 is opened by a user, permeate water is forced from tank 22 and through a carbon filter 70 though the faucet 72 for use by a user. Concentrate water is routed from outlet port 50 through a waste water tube 78, having a flow restrictor 26, through a drain tube 74 for subsequent disposal down drain 68. A membrane suitable for this embodiment is manufactured by Applied Membranes, Inc. of Vista, Calif. under part number MT1812P24.

Using process 200, the user retrofits system 10 to form ZWRO water filtering system 110. The user turns-off (202) a supply of hot water from hot water source 82 and a supply of cold water from cold water source 84 by closing a hot water valve 56 and a cold water angle stop valve 36 respectively. The user drains (204) tank 22 by opening air gap faucet 72 and the pressure in tank 22 forces the permeate water from the tank and through the faucet. The user disconnects (208) a standard hot water sink valve 56 from a hot water supply line 76. Hot water supply line 76 supplies hot water to standard faucet 62 from hot water source 82. The user installs (212) a valve on the hot water angle stop valve 66, which is similar to cold water angle stop valve 36. A valve for the hot water angle stop valve 66 suitable for this embodiment is manufactured by CNC of Taipei, Taiwan under part number 32175682CNC.

The user reconnects (216) hot water faucet supply line 76 to hot water angle stop valve 66. The user removes (220) waste water tube 78 from membrane 18 by cutting tube 78 at the membrane. The user cuts (224) waste water tube 78 about 6″ from a faucet connection 79. The user attaches (228) a tube assembly 80 that has a flow restrictor 86 and two check valves (e.g., check valve 88a and check valve 88b). One end of tube assembly 80 having flow restrictor 86 is attached to concentrate port 50 of membrane 18 and the other end of the tube assembly is connected to hot water angle stop valve 66. Flow restrictor 86 is a larger rated flow restrictor than flow restrictor 26 to offset the back pressure from hot water source. In one embodiment, the flow rate of flow restrictor 86 is between 500 ml/m to 600 ml/m. Even though flow restrictor 86 is a larger rated restrictor than flow restrictor 26, the actual flow ratio of concentrate water to permeate water is about the same as system 10. Check valves 88a and 88b prevent hot water from hot water source 82 from entering membrane 18 due to any back pressure that may occur. A flow restrictor suitable for this embodiment is manufactured by Watts Premier of Phoenix, Ariz. under part number 222010. A check valve suitable for this embodiment is manufactured by John Guest USA Inc. of Pine Brook, N.J. under part number ¼ SCV.

The user removes (230) water tube 40 and connects a valve-pump assembly 90 between membrane 18 and filtering system 14. Valve-pump assembly 90 includes a solenoid valve 91, a pump 92, a pump intake tube 93, a valve-pump tube 94 that allows water to flow between the pump and the solenoid valve, a valve outlet tube 95, a pressure switch 96 that is electrically connected to the pump and the solenoid valve by a wire harness 97, and a transformer 98 that supplies power to the pump, the switch, and the valve. The user connects (234) valve-pump assembly 90 by connecting pump intake tube 93 to the filtering system 14 and connecting valve outlet tube 95 to inlet port of membrane 18.

The user disconnects (240) permeate tubes 52a and 52b from shutoff valve 28 and connects (244) the permeate tubes 52a and 52b to pressure switch 96. The user connects (248) transformer 98 to a wall outlet (not shown). Transformer 98 is a 110 VAC to 24 VAC rated transformer.

In operation, the user opens reverse osmosis faucet 72 and the permeate water in tank 10 is forced from the tank by the pressure within the tank. As tank 22 is being depleted of permeate water, pressure switch 96 detects that the pressure within the tank is below a predetermined pressure that corresponds to the tank being filled. Pressure switch 96 electrically opens solenoid valve 91 and electrically engages pump 92 to pump filtered water received from filtering system 14 through the open solenoid valve through outlet valve tube 95 to membrane 18.

Pump 92 continues pumping filtered water to membrane 18 until switch 96 detects that the pressure within tank 22 has reached a predetermined pressure, which corresponds to tank 22 being full or approximately 30 pounds per square inch (psi). At the predetermined pressure, switch 96 electrically disengages pump 92 from pumping filtered water from filter system 14 to membrane 18 and closes solenoid valve 91.

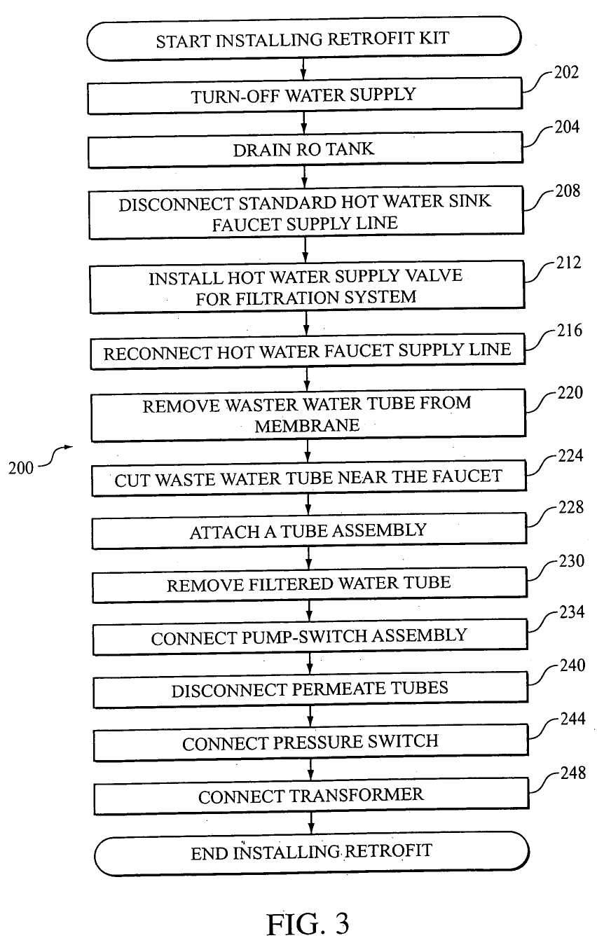

Process 200 is not limited to the specific embodiments described herein. For example, process 200 is not limited to the specific processing order of FIG. 3. Rather, the blocks of FIG. 3 may be re-ordered or eliminated, as necessary, to achieve the results set forth above. For example, system 10 may not include an air gap drain so that the concentrate water is be routed directly to drain 68.

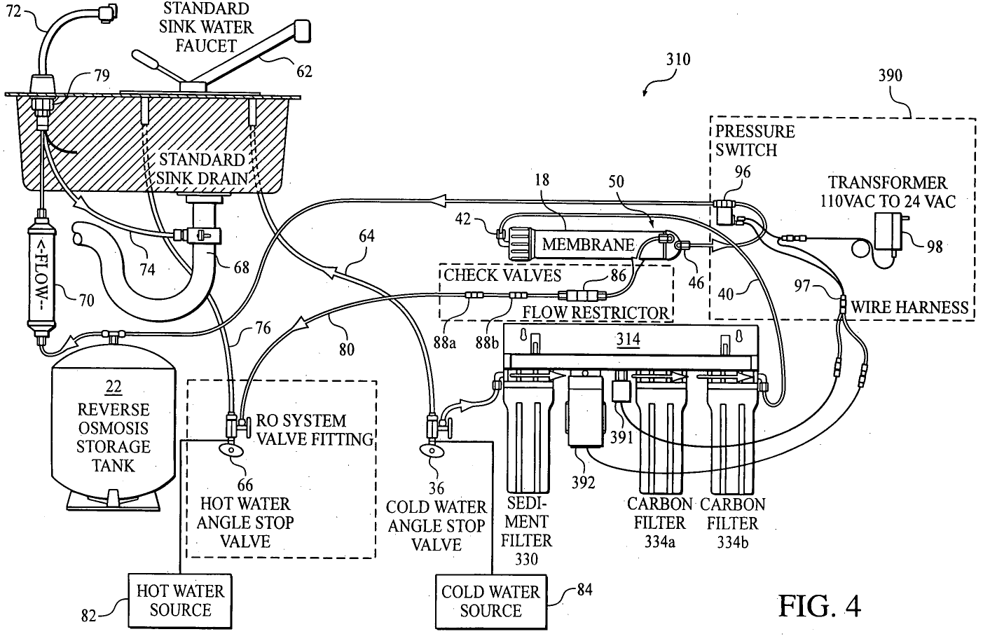

Referring to FIG. 4, system 110 is not limited to the configuration presented. For example, a filtering system 310 may allow access between the sediment filter and the carbon filters. In this configuration, pump 392 and solenoid valve 391 portions of pump switch assembly 390 are positioned between sediment filter 330 and carbon filters 334a and 334b.

In another example, filter system 14 may have only one carbon filter. In other examples of a ZWRO filtering system, an additional filter may be added after membrane 18 and prior to entering hot water source 82 to filter the concentrate water.

In another example, a pressure signal to disengage the pump at a “full” tank condition may be triggered at a predetermined pressure set at less than tank capacity. A signal of tank capacity may alternatively be triggered e.g., by a float or other volume indicator device.

In still other examples, retrofitting a water filtering system includes replacing flow restrictor 26 with flow restrictor 86 that has twice the flow rate of restrictor 26.

In further examples, concentrate water may be connected to any potable water source.

Other embodiments not described herein are also within the scope of the following claims.

1. A method of retrofitting a reverse osmosis system, comprising:
rerouting concentrate water, received from a membrane, from a drain to a water source; and
restricting a flow of the concentrate water to the water source.

2. The method of claim 1, wherein restricting the flow comprises installing a flow restrictor.

3. The method of claim 2, wherein the flow restrictor is a first flow restrictor having a first flow rating and installing comprises replacing a second flow restrictor having a second flow rating with the first flow restrictor, the second flow rating being less than the first flow rating.

4. The method of claim 1, further comprising installing a pump to pump filtered water from a filter system to the membrane.

5. The method of claim 4, further comprising installing a pressure switch configured to disengage the pump when pressure in a tank, receiving permeate water from the membrane, is at a predetermined pressure.

6. The method of claim 4, wherein the predetermined pressure corresponds to the tank being filled with permeate water.

7. The method of claim 1, wherein the water source is a hot water source.
